(19) United States
(12) Patent Application Publication
(10) Pub. No.: US 2026/0342427 A1
(43) Pub. Date: Oct. 29, 2026

(54) Radio Node and Method in a Wireless Communications Network

(71) Applicant: Telefonaktiebolaget LM Ericsson (publ), Stockholm (SE)

(72) Inventor: Bo Göransson, Sollentuna (SE)

(21) Appl. No.: 19/107,906

(22) PCT Filed: Sep. 6, 2022
(86) PCT No.: PCT/EP2022/074739

§ 371 Date: Feb. 28, 2025

(51) Int. Cl. H04B 7/08

(52) U.S. Cl. CPC H04B 7/0874; H04B 7/088

(57) ABSTRACT

A method performed by a network node for handling beamforming of beams to be used for communicating with a User Equipment (UE) in a wireless communications network is provided. The network node determines (602) respective analogue beams to be generated at respective subarrays among a plurality of subarrays in a column of subarrays in a radio node. At least one of the respective analogue beams is different from the other respective analogue beams. The network node sends (603), to the radio node, a first instruction instructing the radio node to generate the determined respective analogue beams. The network node selects (604) a first analogue beam based on a respective quality of the plurality of analogue beams. The selected first analogue beam is the analogue beam with the highest quality. Communication with the UE is based on the selected first analogue beam.

### TECHNICAL FIELD

Embodiments herein relate to a radio node and method therein. In some aspects, they relate to handling beamforming of beams to be used to communicate with a user equipment in a wireless communications network.

### BACKGROUND

In a typical wireless communication network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of Wi-Fi hotspots. 5G research and development also aims at improved support of machine to machine communication, also known as the Internet of things, aiming at lower cost, lower battery consumption and lower latency than 4G equipment.

### Hybrid Beamforming

Hybrid beamforming (HBF), that is, the combination of analogue beamforming (ABF) and digital beamforming (DBF), is an efficient way to support a large antenna system. In a hybrid beamforming system, a number of antenna elements, here referred to as a subarray, are combined with an analogue beamformer comprising power amplifiers (Tx) or low noise amplifiers (Rx) and phase shifters to create analogue beam ports that can be digitized and later combined with digital beamforming. In this disclosure it is assumed that an analogue beamformer is applied between subarrays in one column, while the beamforming between the analogue beam ports within one column and between columns are done in the digital domain.

Note that in this disclosure the term subarray is used to denote the collection of antenna elements connected to one analogue BF. Normally, the term subarray is used to denote the collection of elements connected with a fixed beamformer to form a physical antenna port. This can be seen in FIG. 1a where the fixed subarray comprises two elements. Four of these subarrays are then beamformed by an ABF Radio Frequency (RF) Application-Specific Integrated Circuitry (ASIC).

An example implementation of an antenna array is depicted in FIG. 1a where an ABF RF ASIC is connected to eight elements in one column. Here it is assumed that each analogue beamformer can generate one out of K possible beams. In FIG. 1b it is assumed that K=3. The ABF RF ASIC creates one beam pointing in a specific vertical direction. By this, a so called slice of the vertical domain is filtered out. By using DBF between the beam-ports created by the ABF, a more narrow and higher gain beam can then be generated in digital domain. This is illustrated in FIG. 2 where the analogue beamformers are slicing the vertical domain into 3 different coverage areas and where the DBF, in elevation, may fine tune the resulting beam within the coverage area of the ABF.

To maximize the coverage the same analogue beam is generated in each beamformer, compensated for the distance between subarrays, by this the combined analogue beam will have highest gain. An example is shown in FIG. 3a andb, where one out of three different beams may be generated in each beamformer, see FIG. 3a, the resulting beams when co-phasing all L=4 subarrays is also shown in FIG. 3b. The dashed lines are used to indicate the wanted vertical service area for the total array.

Legacy beam acquisition based on beam sweeping may be described with help of FIGS. 3a and b. All subarrays generate the same analogue beam, e.g., the topmost in FIG. 3a. The output signal from each beamformer, i.e., subarray, is then co-phased to generate a high gain beam, e.g., topmost in FIG. 3b. The quality of the received signal, such as beam, for each UE is then calculated. Alternatively, a Channel State Information Reference Signal (CSI-RS) is transmitted in the generated beam, and the response from each UE is collected in the network. This process is then repeated for all available beams, one at the time. Finally, the best beam, e.g., the beam with the highest quality, is then obtained by comparing a quality measure between all used beams. The quality measure may e.g., be RSRP, SNR, SNIR or similar.

### Narrow Band Receiver

Digitizing each analogue beam port over the full bandwidth (>1 GHz) would generate an enormous amount of digital data that should be processed by baseband. To limit the bitrate on digital interfaces, a narrow band receiver (NBR) may be applied to the ports generated by the ABF. The NBR only digitize a fraction of the supported bandwidth on each beam port. To estimate spatial parameters such as suitable, e.g., wideband beamformer weights, received power in a certain direction etc., it is normally enough with narrow band data. In what follows, it is assumed that the NBR is digitizing a part of the supported bandwidth on each port generated by the analogue beamformers. Using the example implementation in FIG. 1a, each column generates 4 beam ports, and there are 24 columns, hence the NBR digitize narrow band data from 96 ports per polarization. This in contrast to if only DBF should be used over the array when 8×4×24=768 ports of wideband data should be digitized.

### SUMMARY

As part of developing embodiments herein a problem was identified by the inventor and will first be discussed.

There are, in principle, two ways for the system to get an understanding of which beam to use for each UE. Note that in the case of HBF, both information of the best analogue beam, and the best digital beam is needed when scheduling a UE. A best beam may also be referred to as the beam, analogue and/or digital with the highest quality. Note also that it is assumed that there exists a finite set of possible beams. This is sometimes referred to as codebook-based beamforming or precoding, this since the weights for all possible beams are stored in a table, e.g., referred to as a codebook. A first method is to schedule a CSI-RS in each beam, and then let the UE report the Reference Signal Receive Power (RSRP) for each beam which could then be compared. Note that it is only possible to generate one analogue beam per time, and hence the CSI-RS sent in each analogue beam needs to be time multiplexed. An alternative method is to let the UE transmit an SRS and then measure the received power, or any other measure of quality, in each possible analogue beam. Since it is only possible to measure in one analogue beam at a single time instant, the UE need to transmit several time multiplexed SRS so that the gNB can do measurements on a different beam in each time instant.

This process, both CSI-RS based and SRS based, is sometimes referred to as beam sweeping, since a gNB is sweeping its active beam over the service area.

The main problem with the beam sweeping procedure described above is the required overhead and the time it takes to acquire knowledge of the preferred beam for a specific UE. If the system has many beams this process may consume much of the available resources since it may not be possible to mix data for one UE and e.g., Channel State Information—Reference Signal (CSI-RS) for another UE if they should be served in different directions.

An object of embodiments herein is to improve the performance of a wireless communications network by a more efficient beamforming.

According to an aspect of embodiments herein, the object is achieved by a method performed by a radio node. The method is for handling beamforming of beams to be used for communicating with a User Equipment, UE, in a wireless communications network. The radio node comprises an antenna array comprising a plurality of subarrays. A subarray of the plurality of subarrays comprises one or more elements connected to an analogue beamformer, ABF, associated to the subarray.

The radio node receives a first instruction from a network node. The first instruction instructs the radio node to generate respective analogue beams.

The radio node generates, at a plurality of subarrays in a column of subarrays, respective analogue beams. The analogue beam for a subarray is generated by the associated ABF. At least one of the respective analogue beam is different from the other respective analogue beams.

According to another aspect of embodiments herein, the object is achieved by a method performed by a network node for handling beamforming of beams to be used for communicating with a User Equipment, UE, in a wireless communications network.

The network node determines respective analogue beams to be generated at respective subarrays among a plurality of subarrays in a column of subarrays in a radio node. At least one of the respective analogue beams is different from the other respective analogue beams.

The network node sends a first instruction to the radio node. The first instruction instructs the radio node to generate the determined respective analogue beams.

The network node selects a first analogue beam based on a respective quality of the plurality of analogue beams. The selected first analogue beam is the analogue beam with the highest quality. Communication with the UE is based on the selected first analogue beam.

According to another aspect of embodiments herein, the object is achieved by a radio node configured to handle beamforming of a beam adapted to be used to communicate with a User Equipment, UE, in a wireless communications network. The radio node is arranged to comprise an antenna array adapted to comprise a plurality of subarrays. A subarray of the plurality of subarrays is adapted to comprise one or more elements connected to an analogue beamformer, ABF. The ABF is adapted to be associated to the subarray. The radio node is further configured to:
Generate, at a plurality of subarrays in a column of subarrays, respective analogue beams, the analogue beam for a subarray adapted to be generated by the associated ABF, wherein at least one of the respective analogue beams is adapted to be different from the other respective analogue beams,
select a first analogue beam based on a respective quality of the plurality of analogue beams, wherein the selected first analogue beam is adapted to be the analogue beam with the highest quality, wherein communication with the UE is adapted to be based on the selected analogue beam.

According to another aspect of embodiments herein, the object is achieved by a network node configured to handle beamforming of beams adapted to be used to communicate with a User Equipment, UE, in a wireless communications network. The network node further being configured to:
Determine respective analogue beams to be generated at respective subarrays among a plurality of subarrays in a column of subarrays in a radio node (110), wherein at least one of the respective analogue beams is adapted to be different from the other respective analogue beams,
send, to the radio node (110), a first instruction adapted to instruct the radio node (110) to generate the determined respective analogue beams, and
select a first analogue beam based on a respective quality of the plurality of analogue beams, wherein the selected first analogue beam is the analogue beam with the highest quality, wherein communication with the UE (121) is adapted to be based on the selected first analogue beam.

According to another aspect of embodiments herein, the object is achieved by a system comprising one or more nodes configured to handle beamforming of beams adapted to be used for communicating with a User Equipment, UE, in a wireless communications network. The one or more nodes are adapted to operate in the wireless communications system. The system further being configured to:
Determine respective analogue beams adapted to be generated at respective subarrays among a plurality of subarrays in a column of subarrays, wherein at least one of the respective analogue beams is adapted to be different from the other respective analogue beams,
generate, at the plurality of subarrays in the column of subarrays, the respective analogue beams, an analogue beam for a subarray is adapted to be generated by an associated analogue beamformer, ABF, and
select a first analogue beam based on a respective quality of the plurality of analogue beams, wherein the selected first analogue beam is adapted to be the analogue beam with the highest quality, wherein communication with the UE (121) is adapted to be based on the selected first analogue beam.

In this way, a more efficient beamforming is achieved. This since it is when determining to generating the respective analogue beams at a plurality of subarrays in a column of subarrays, at least one of the analogue beams is different from the other analogue beams, the respective beams are generated, a first analogue beam is selected based on a respective quality of the plurality of analogue beams, and communication with the UE is based on the first analogue beam. Embodiments herein e.g., brings the advantages of achieving an efficient beamforming by simultaneously generating different analogue beams when performing beamforming, and thus minimizing the amount of beam sweeping needed for analogue beam acquisition and improving the performance of the wireless communications network. This results in an improved performance of the wireless communications network by an efficient beamforming.

### BRIEF DESCRIPTION OF THE DRAWINGS

Examples of embodiments herein are described in more detail with reference to attached drawings in which:

FIG. 1a is a schematic overview of an antenna array.

FIG. 1b is a schematic diagram illustrating prior art.

FIG. 2 is a schematic block diagram illustrating beamforming.

FIGS. 3 a and b are schematic diagrams illustrating beamforming.

FIG. 4 is a schematic block diagram illustrating embodiments of a wireless communications network.

FIG. 5 is a flowchart depicting embodiments of a method in a radio node.

FIG. 6 is a flowchart depicting embodiments of a method in a network node.

FIG. 7 is a flowchart depicting embodiments of a method in a system.

FIGS. 8 a and b are schematic block diagrams illustrating examples of embodiments herein.

FIGS. 9 a and b are schematic block diagrams illustrating examples of embodiments herein.

FIG. 10 is a schematic block diagram illustrating examples of embodiments herein.

FIGS. 11 a and b are schematic block diagrams illustrating embodiments of a radio node.

FIGS. 12 a and b are schematic block diagrams illustrating embodiments of a network node.

FIG. 13 schematically illustrates a telecommunication network connected via an intermediate network to a host computer.

FIG. 14 is a generalized block diagram of a host computer communicating via a base station with a user equipment over a partially wireless connection.

FIGS. 15 to 18 are flowcharts illustrating methods implemented in a communication system including a host computer, a base station, and a user equipment.

### DETAILED DESCRIPTION

Embodiments herein relate to a wireless communications network and the handling of beamforming of beams to be used by a radio node for communication with a UE.

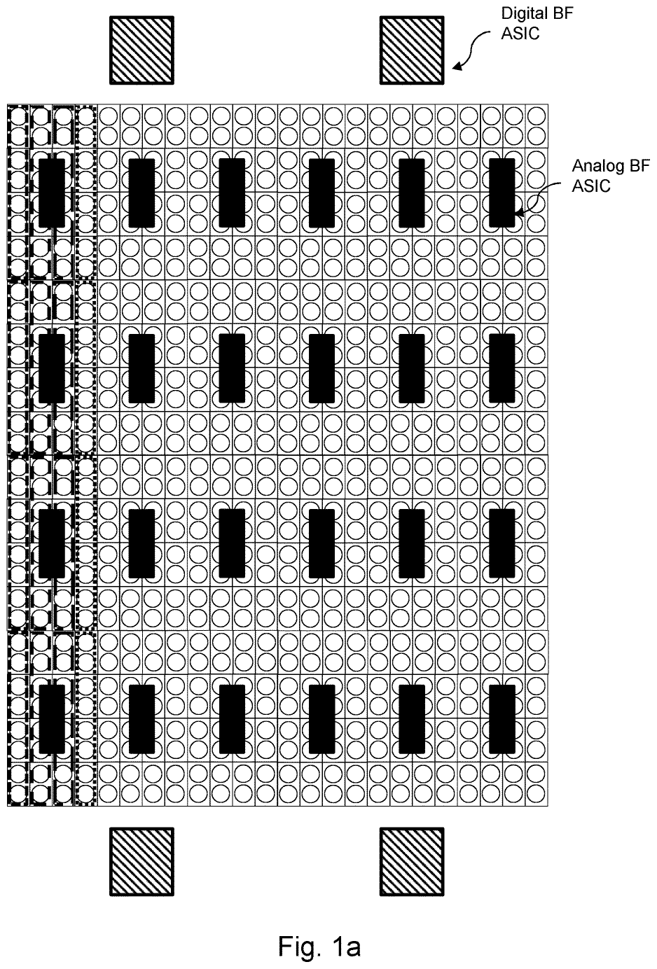

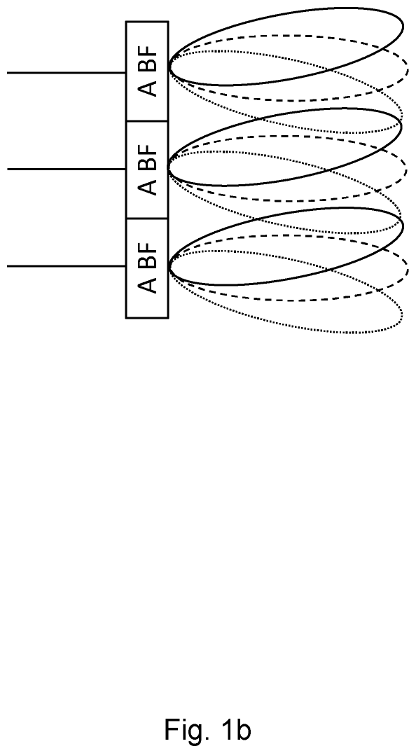

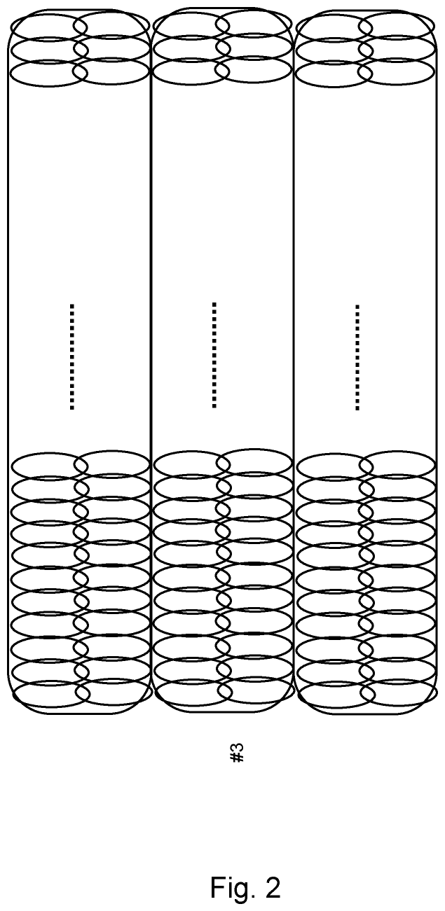

A legacy implementation of HBF is, as discussed above, depicted in FIGS. 1a and b where an ABF RF ASIC is connected to eight elements in one column. The elements in a column connected to the same ABF RF ASIC is also referred to as a subarray. Here it is assumed that each analogue beamformer can generate one out of K possible beams. In FIG. 1b it is assumed that K=3. The ABF RF ASIC create one beam pointing in a specific vertical direction. By this, a so called slice of the vertical domain is filtered out. By using DBF between the beam-ports created by the ABF, a more narrow and higher gain beam can then be generated in digital domain. This is illustrated in FIG. 2 where the analogue beamformers are slicing the vertical domain into 3 different coverage areas and where the DBF, in elevation, may fine tune the resulting beam within the coverage area of the ABF. According to this legacy implementation, each ABF may generate 3 different beams. But since the analogue ASIC only contain one BF, per polarizations, and all subarrays in a column of subarrays generates the beams pointing in the same direction, i.e., the beams generated by the subarrays in a column is generated based on the same beam settings, only one slice may be active in each time instant. This means that to find the best beam, e.g., the beam with the highest quality, beam sweeping needs to be performed, which increases the signaling overhead and time required for beam acquisition.

According to examples of embodiments herein, in order to speed up the beam acquisition, e.g., analogue beam acquisition, different analogue beams are created at each subarray in a column. In some examples, the signals generated from each specific beam is further beamformed in digital domain to create a final signal and the quality of this signal is then compared to the signal generated from other beam settings. The beam setting with highest quality, e.g., received power, will be selected as the analogue beam setting for a particular UE. A simple example would be to have one beam setting for all subarrays in the first row, a second beam setting for all subarrays in a second row, etc. The output signal will then be generated by digital beamforming between all columns. Note that this is only one very common implementation, but the embodiments provided herein would also be applicable if ABF is done between antenna columns, or even if ABF is applied to both columns and rows. For simplicity the single polarized case is described herein, but in practice the antenna normally consists of dual polarized elements. The two polarizations are independent, and hence the embodiments provided herein may be applied to each polarization separately.

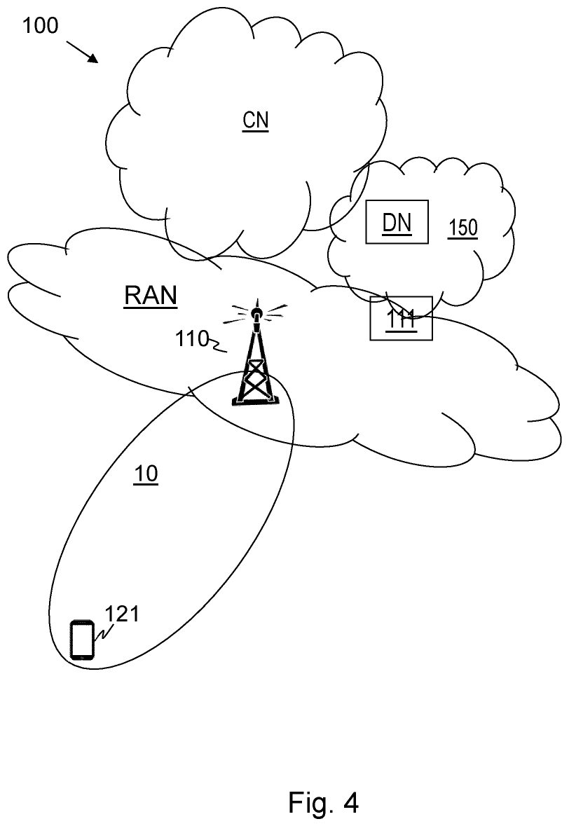

FIG. 4 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, New Radio (NR), 6G, Wideband Code Division Multiple Access (WCDMA), Global System for Mobile communications/enhanced Data rate for GSM Evolution (GSM/EDGE), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of RAN nodes operate in the communications network 100 such as e.g. the radio node 110. The radio node 110 provides radio coverage in a number of cells which may also be referred to as a beam or a beam group of beams, such as a cell 10 provided by the radio node 110.

The radio node 110 may be any of an NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a UE 121 within the service area served by the radio node 110 depending e.g. on the radio access technology and terminology used. The radio node 110 may be referred to as a serving RAN node and communicates with UEs such as the UE 121, with Downlink (DL) transmissions to the UE 121, and in Uplink (UL) transmissions from the UE 121.

A number of UEs operate in the communication network 100, such as e.g. the UE 121. The UE 121 may also be referred to as an IoT device, a mobile station, a non-access point (non-AP), a STA, and/or a wireless terminal. It should be understood by the skilled in the art that “UE” is a non-limiting term which means any terminal, wireless communication terminal, user equipment, Machine Type Communication (MTC) device, Device to Device (D2D) terminal, a radio device in a vehicle, or node e.g. smart phone, laptop, mobile phone, sensor, relay, mobile tablets or even a small base station communicating within a cell.

A network node 111 operates in the wireless communications network 100. The network node 111 may also be referred to as a baseband node 111, or alternatively a cloud node 111, when operating a cloud 150. When referred to as cloud node 111, the cloud node 111 may implement functionality of a baseband node.

Methods herein may be performed by the radio node 110 As an alternative, a Distributed Node (DN) and functionality, e.g. comprised in the cloud 150 as shown in FIG. 4, may be used for performing or partly performing the methods herein.

Examples of embodiments herein may provide the advantage that many analogue beams can be measured each time. By this, no or a minimum of beam sweeping is needed for the analogue beam acquisition and hence resources that are blocked in the prior art beam sweeping procedure may be used to transmit and/or receive data with lower latency and increase system capacity, and thus improving the performance of the wireless communications network 100.

A number of embodiments will now be described, some of which may be seen as alternatives, while some may be used in combination.

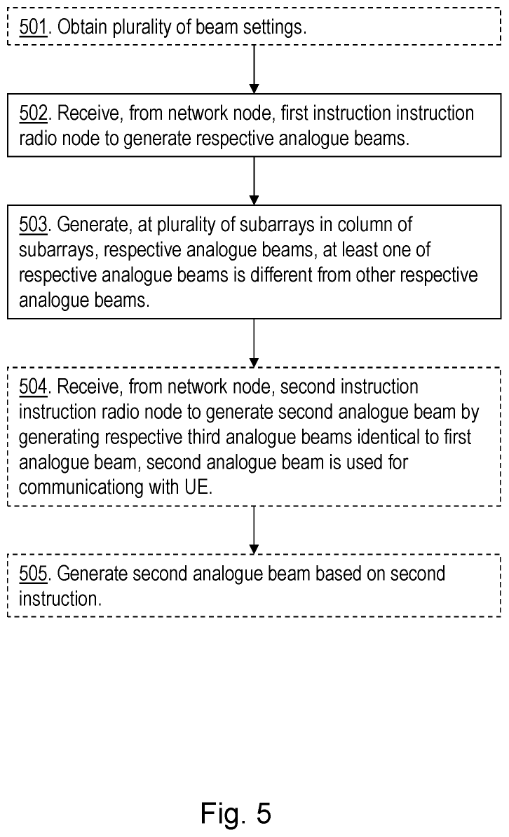

The embodiments of a method will be generally described in view of the radio node 110 together with FIG. 5. This will be followed by a more detailed description.

A method according to embodiments will now be described from the view of the radio node 110 together with FIG. 5. FIG. 5 depicts example embodiments of a method performed by the radio node 110 for handling beamforming of beams to be used for communicating with the UE 121 in the wireless communications network 100. The radio node 110 comprises an antenna array. The antenna array comprises a plurality of subarrays. A subarray of the plurality of subarrays comprises one or more elements connected to an ABF associated to the subarray. Communicating with the UE 121 may mean transmitting and/or receiving wireless signals, such as e.g., data, to and/or from the UE 121. The method comprises the following actions, which actions may be taken in any suitable order. Actions that are optional are presented in dashed boxes in FIG. 5.

### Action 501

In some embodiments, the radio node 110 obtains a plurality of beam settings for generating analogue beams. The beam settings may be preconfigured in the radio node 110. This may mean that the radio node 110 obtains the beam settings from a configuration, e.g., stored in the radio node 110. The obtained beam settings may be a set of beam settings. The beam settings in the set of beam settings may be different beam settings.

Beam settings when used herein may e.g., mean the amplitude and phase settings that should be applied to each subarray.

### Action 502

The radio node 110 receives a first instruction from the network node 111. The first instruction instructs the radio node 110 to generate respective analogue beams.

### Action 503

The radio node 110 generates respective analogue beams at a plurality of subarrays in a column of subarrays based on the first instruction. The analogue beam for a subarray is generated by the associated ABF. At least one of the respective analogue beams is different from the other respective analogue beams. This may mean that the analogue beam generated for at least one subarray in the column of subarrays, is different from the analogue beams generated for the remaining subarrays in the column of subarrays. In some examples, the analogue beams for at least two subarrays are identical, while the analogue beams for the remaining subarrays are all different. Alternatively, the beams for at least two of the remaining subarrays are identical to each other. In other words, the radio node 110 generates analogue beams for all subarrays in a column of subarrays, where at least one beam differs from the remaining beams. Thus, more than one analogue beam may be evaluated at the same time, reducing the resource consumption.

In some embodiments, all the respective analogue beams are different analogue beams.

The respective analogue beams may be generated based on the obtained beam settings. This may mean that the analogue beams are generated using beam settings from the obtained beam settings. Identical analogue beams may mean that they are generated using the same obtained beam settings. Consequently, different analogue beams may mean analogue beams generated using different beam settings.

In some embodiments, the radio node 110 generates the plurality of analogue beams by further performing digital beamforming of the plurality of analogue beams.

Performing digital beamforming may mean performing beamforming in the digital domain.

### Action 504

In some embodiments, the radio node 110 receives a second instruction from the network node 111. The second instruction instructs the radio node 110 to generate a second analogue beam by generating respective third analogue beams at the plurality of subarrays in the column of subarrays. The respective third analogue beams are identical to the selected first analogue beam. The second analogue beam is used for communicating with the UE 121.

### Action 505

In some embodiment, the radio node 110 generates the second analogue beam based on the second instruction. Thus, the radio node 110 generates a second analogue beam by generating respective third analogue beams at the plurality of subarrays in the column of subarrays. The respective third analogue beams are identical to the selected first analogue beam. The second analogue beam is used for communicating with the UE 121.

In some embodiments, the radio node 110 generates the second analogue beam by performing beamforming in the digital domain between the respective third analogue beams.

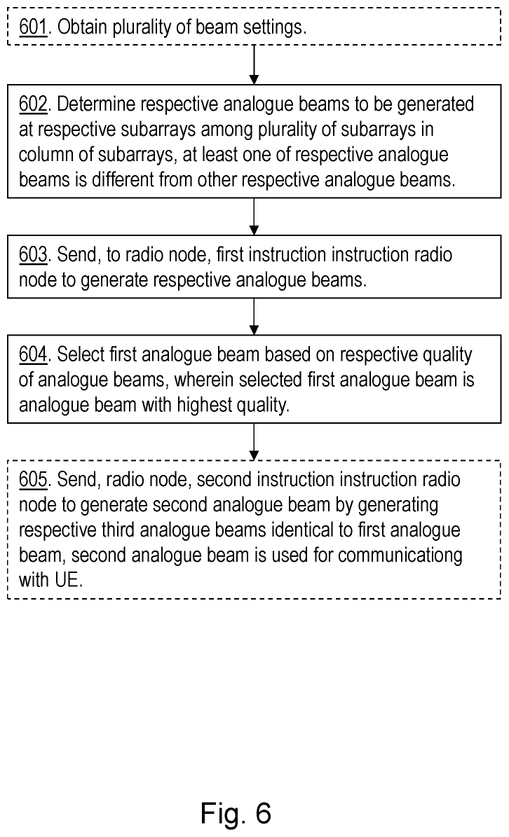

A method according to embodiments will now be described from the view of the network node 111 together with FIG. 6. FIG. 6 depicts example embodiments of a method performed by the network node 111 for handling beamforming of beams to be used for communicating with the UE 121 in the wireless communications network 100. Communicating with the UE 121 may mean transmitting and/or receiving wireless signals, such as e.g., data, to and/or from the UE 121. The network node 111 may be any one out of a baseband node 111, or a cloud node 111 implementing the functionality of a baseband node. When the network node 111 is a baseband node 111, the baseband node 111 may be collocated with the radio node 110 or located separate from the radio node 110.

The method comprises the following actions, which actions may be taken in any suitable order. Actions that are optional are presented in dashed boxes in FIG. 6.

### Action 601

In some embodiments, the network node 111 obtains a plurality of beam settings for generating analogue beams. The beam settings may be preconfigured in the network node 111. This may mean that the network node 111 obtains the beam settings from a configuration, e.g., stored in the radio node 111. The obtained beam settings may be a set of beam settings. The beam settings in the set of beam settings may be different beam settings.

Beam settings when used herein may e.g., mean the amplitude and phase settings that should be applied to each subarray.

### Action 602

The network node 111 determines respective analogue beams to be generated at respective subarrays among a plurality of subarrays in a column of subarrays in the radio node 110. At least one of the respective analogue beams is different from the other respective analogue beams.

In some embodiments, the determined respective analogue beams are associated to respective beam settings from the plurality of beam settings. The first instruction may comprise any one or more out of the respective beam settings, e.g., associated to the determined respective analogue beams, and an indication of the respective beam settings, e.g., associated to the determined respective analogue beams.

### Action 603

The network node 111 sends a first instruction to the radio node 110. The first instruction instructs the radio node 110 to generate the determined respective analogue beams, and

### Action 604

The network node 111 may then need to select a beam to communicate with the UE 121, e.g., for transmitting and/or receiving data.

The network node 111 selects a first analogue beam based on a respective quality of the plurality of analogue beams. The selected first analogue beam is the analogue beam with the highest quality. Communication with the UE 121 is based on the selected first analogue beam.

In other words, the network node 111 selects the first analogue beam on which the communicating with the UE 121 is to be based. The selection is based on the respective quality of the plurality of analogue beams, and the analogue beam with the highest quality is selected.

For example, as also described below, CSI-RS may be transmitted on the plurality of analogue beam. The quality of the plurality of analogue beams may be determined based on a response received from the UE 121, e.g., measurements performed by the UE 121 received in one or more measurement reports. The quality may e.g., be related to one or more out of RSRP, Signal to Noise Ratio (SNR), Signal to Noise and Interference Ratio (SNIR). Alternatively, the quality of the plurality of analogue beams may be determined based on measurements on SRS transmitted by the UE 121 on the plurality of analogue beams. This may mean that the UE 121 transmits SRS and the network node 111 performs measurements on the received SRS in order to determine the quality. The quality may e.g., be related to one or more out of RSRP, SNR, and SNIR. Alternatively, the network node 111 receives, from the radio node 110, measurements on the SRS transmitted by the UE 121, where the measurements is performed by the radio node 110. Alternatively, the quality is determined by the radio node 110, either by CSI-RS and/or SRS as described above, and the network node 111 receives the determined quality of the plurality of analogue beams from the radio node 110.

In some embodiments, the network node 111 selects the first analogue beam further based on the quality of the quality of the plurality of analogue beamformed beams beamformed in the digital domain.

### Action 605

In some embodiments, the network node 111 sends a second instruction to the radio node 110. The second instruction instructs the radio node 110 to generate a second analogue beam by generating respective third analogue beams at the plurality of subarrays in the column of subarrays. The respective third analogue beams are identical to the selected first analogue beam. The second analogue beam is used for communicating with the UE 121.

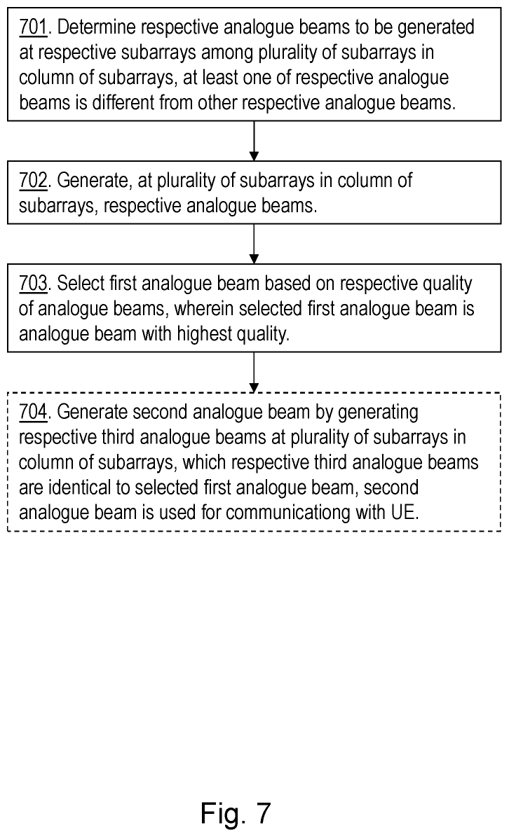

A method according to embodiments will now be described from the view of a system together with FIG. 7. FIG. 7 depicts example embodiments of a method performed by the system comprises one or more nodes 110, 111 for handling beamforming of beams to be used for communicating with the UE 121 in the wireless communications network 100. The one or more nodes 110, 111 operates in the wireless communications system 100. Communicating with the UE 121 may mean transmitting and/or receiving wireless signals, such as e.g., data, to and/or from the UE 121. The one or more nodes 110, 111 may e.g., be any one or more out of the radio node 110 and the network node 111. The actions below may be performed by the one or more nodes 110, 111. Some of the actions may be performed one of the one or more nodes 110, 111, while other actions are performed another of the one or more nodes 110, 111, in any suitable combinations. The action below may be combined with any of the action described above in relation to FIGS. 5 and 6.

The method comprises the following actions, which actions may be taken in any suitable order. Actions that are optional are presented in dashed boxes in FIG. 7.

### Action 701

The system determines respective analogue beams to be generated at respective subarrays among a plurality of subarrays in a column of subarrays. At least one of the respective analogue beams is different from the other respective analogue beams.

### Action 702

The system generates, at the plurality of subarrays in the column of subarrays, the respective analogue beams. An analogue beam for a subarray is generated by an associated ABF.

### Action 703

The system selects a first analogue beam based on a respective quality of the plurality of analogue beams. The selected first analogue beam is the analogue beam with the highest quality. Communication with the UE 121 is based on the selected analogue first beam.

### Action 704

In some embodiment, the system generates a second analogue beam based by generating respective third analogue beams at the plurality of subarrays in the column of subarrays. The respective third analogue beams are identical to the selected first analogue beam. The second analogue beam is used for communicating with the UE 121. The second analogue beam may be generated by performing beamforming in the digital domain between the respective third analogue beams.

Embodiments mentioned above will now be further described and exemplified. The embodiments below are applicable to and may be combined with any suitable embodiment described above.

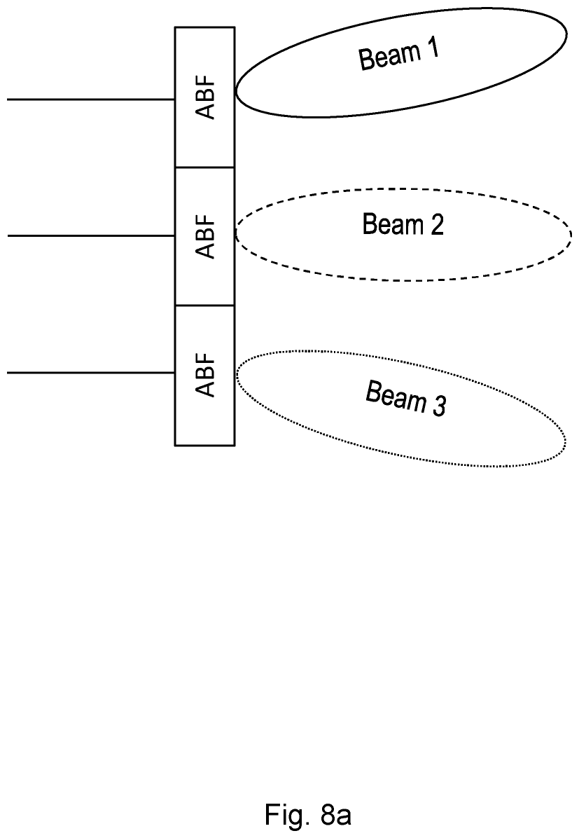

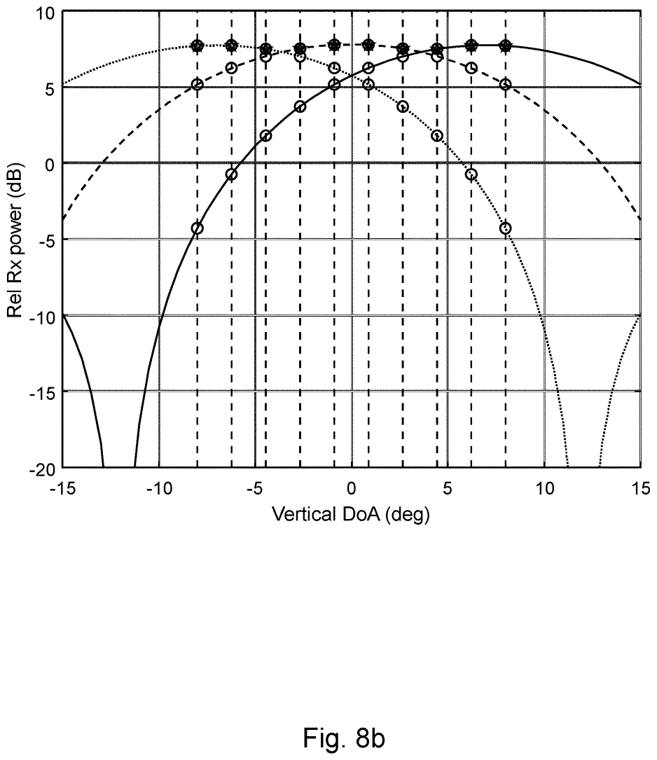

An example of embodiments herein may be described from FIGS. 8a and b. In this example there are three subarrays per column where each subarray is associated to an ABF, as shown in FIG. 8a. Each subarray has its own beam setting, e.g., one entry in the table, also referred to as codebook, of available beam settings. Each subarray generates a respective beam, such as beam 1, beam 2 and beam 3, based on its beam settings. In FIGS. 8a and b, beam 1 is illustrated by a solid line, beam 2 by a dashed line and beam 3 by a dotted line. FIG. 8b shows the received power in each beam (shown as circles) from a UE, such as the UE 121, located at the dashed lines.

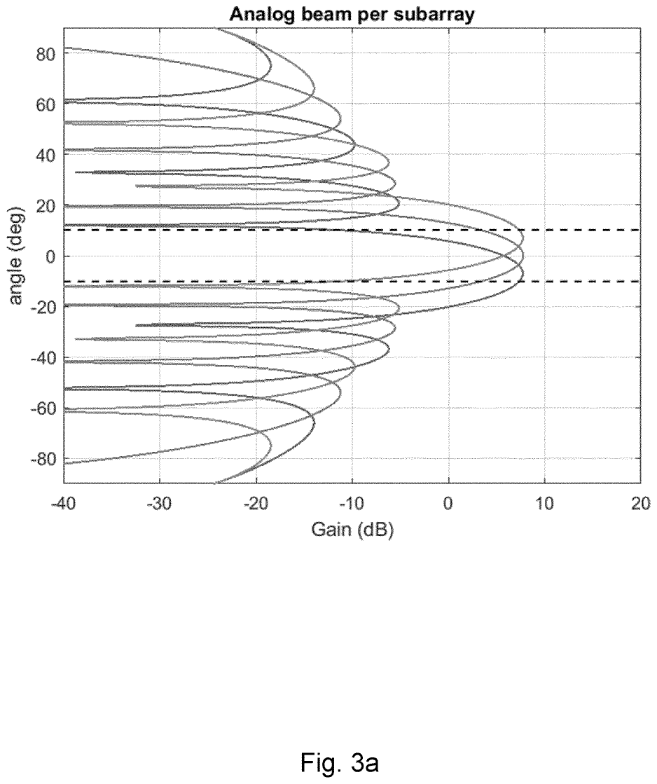

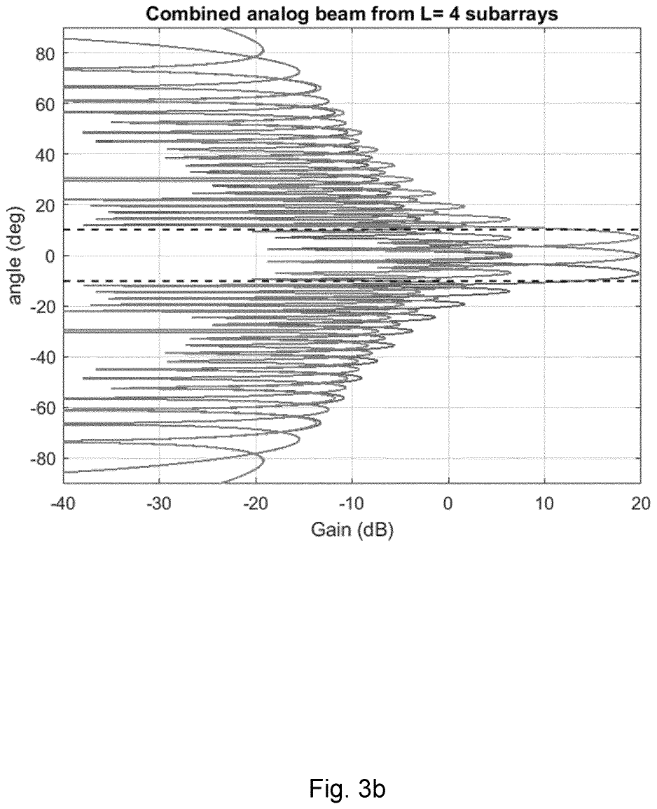

As may be seen from FIG. 8b, a UE located above 5 degrees vertical Direction of Arrival (DoA), it is evident that beam 1 has the highest received power, and hence beam 1 should be used for these UEs. Similarly, between 2 and −2 degrees vertical DoA, beam 2 is best, i.e. most suitable, beam, e.g., has the highest received power, and should be used. It may also be noted that for certain vertical DoAs, it may not be clear which beam is best, e.g., has the highest received power. For example, at −4 degrees vertical DoA beam 2 and beam 3 have very similar received power levels, and it may not be possible to select a best, e.g., most suitable, beam. The same happens for a UEs located at 4 degrees vertical DoA. In this particular example, this occur since the available beams are symmetric around the horizon. A similar power level of two beams may indicate that the UE, e.g., the UE 121, is located in the cross-over region between two high gain beams, see e.g., FIG. 3b, and similar performance may be expected regardless of which beam is selected.

In the example above, the number of available beams coincide with the number of subarrays in a column. In many cases this will not be the case. If a tall antenna array with many subarrays is used in a scenario which require a smaller coverage angular range, there may be many measurements per available beam. In such a case, the same beam setting can be used for several rows of subarrays in a column of subarrays. The outputs may then be co-phased, such as beamformed, in the digital domain to create a higher gain and hence better estimates.

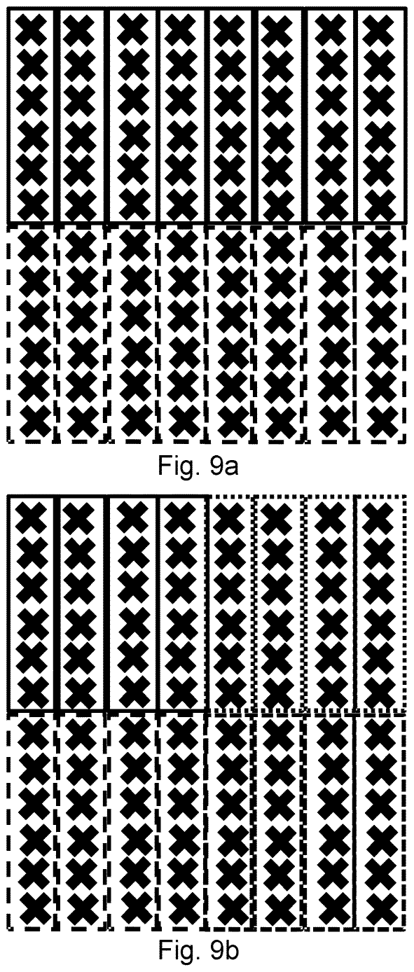

The other situation, when the number of available beam settings are larger, in some case much larger, than the number of subarrays in a column of subarrays, may be addressed in two ways. The first solution would be to use a first subset of the available beam settings, e.g., as many as the available subarrays in a column of subarrays. The process may then be repeated with a different set of beam settings. This procedure then may include some beam sweeping, however since several beams are measured in each sweep, there is still a saving compared to legacy operation of the system. The second way would be to use fewer columns per beam setting. In FIGS. 9a andb two cases are shown. In the first case, as shown in FIG. 9a, all columns are used for a single beam setting. In the second case, as shown in FIG. 9b, twice the number of beam settings can be measured per time unit by using fewer columns per beam setting. It should be noted that since fewer columns, and hence a smaller array, are used for each beam setting when more beams are measured, the received, or transmitted, power will be lower per beam and hence a proper link budget analysis may be needed to ensure that enough beamforming gain is generated.

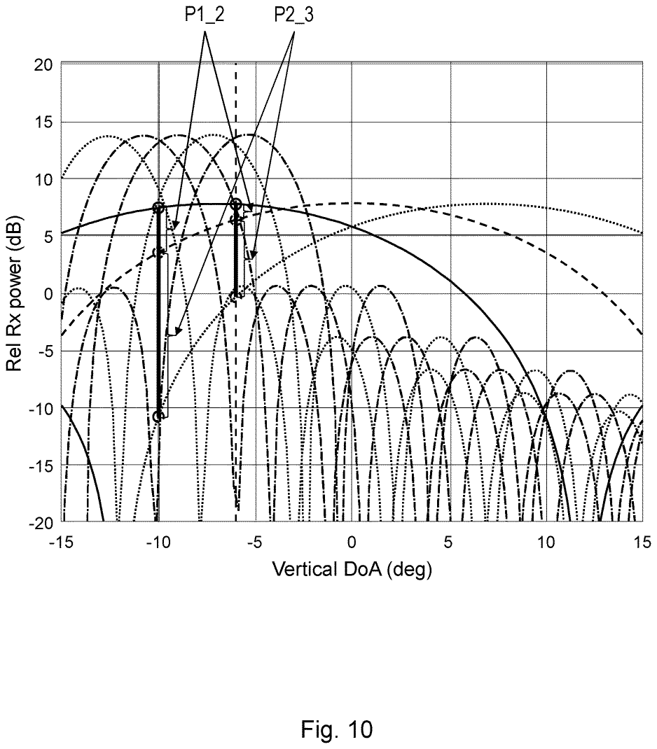

In the examples above, the focus has been on finding the best, such as most suitable, analogue beam setting, e.g., with the highest received power, for a specific UE, e.g., the UE 121. However, the according to embodiments herein, it may also be possible to indicate the direction of the beam that should be generated by DBF. By studying the received power difference between two adjacent analogue beams, it may be possible to judge where the generated digital beam should point, such as the direction of the digital beam. FIG. 10 shows a case where analogue beam 1 is selected for two different UEs, e.g., the UE 121 and a different UE.

The power difference per analogue beam pair may be measured and tabulated as a function of direction in an anechoic chamber, and by this an estimate of the direction may be obtained by comparing the measured power per beam with the tabulated values. For example, the measured power difference between analogue beam 1 and 2 (P1_2) and analogue beam 2 and 3 (P2_3) may indicate that certain digital beams would be appropriate here. Note that since each row of subarrays may generate an analogue beam pointing in different directions, it may not, in general, be possible to calculate the best, digital beam, e.g., the digital beam with the highest quality such as highest RSRP, SNR and/or SINR, by just applying digital codebook vectors to the output of the ABF nodes. This since when transmitting or receiving data, all analogue subarray beams should point in the same direction to maximize Effective Isotropic Radiated Power (EIRP) and/or Effective Isotropic Sensitivity (EIS).

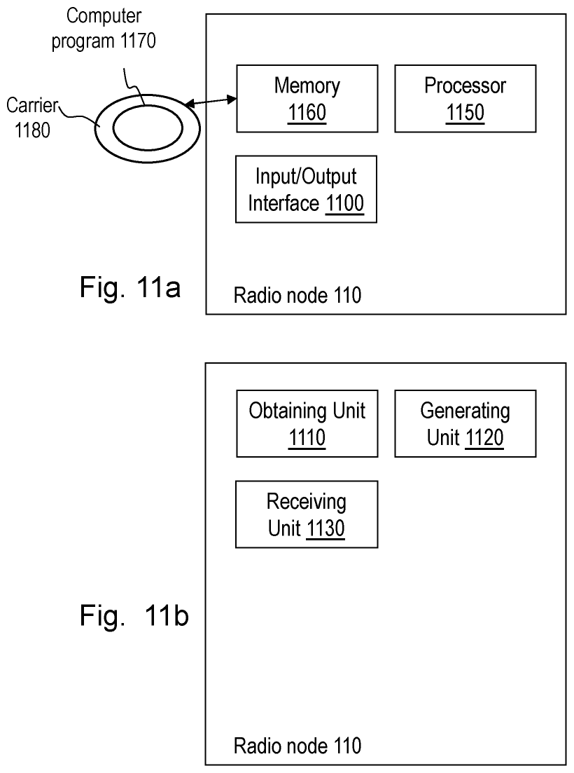

To perform the method actions, the radio node 110 may comprise an arrangement depicted in FIGS. 11a andb. The radio node 110 is configured to handle beamforming of a beam adapted to be used to communicate with the UE 121 in the wireless communications network 100. The radio node 110 is arranged to comprise an antenna array adapted to consist of a plurality of subarrays. A subarray of the plurality of subarrays is adapted to comprise one or more elements connected to an ABF adapted to be associated to the subarray.

The radio node 110 may comprise an input and output interface 1100 configured to communicate with e.g. the UE 121 and with network nodes in the communications network 100.

The radio node 110 may further be configured to, e.g. by means of an obtaining unit 1110 in the radio node 110, obtain a plurality of beam settings for generating analogue beams.

The radio node 110 is further configured to, e.g. by means of a generating unit 1120 in the radio node 110, generate, at a plurality of subarrays in a column of subarrays, respective analogue beams based on the first instruction. The analogue beam for a subarray is adapted to be generated by the associated ABF. At least one of the respective analogue beams is adapted to be different from the other respective analogue beams.

All the respective analogue beams may be adapted to be different analogue beams.

The radio node 110 may further configured to generate the respective analogue beams based on the obtained beam settings.

The radio node 110 may be configured to generate the plurality of analogue beams by further being configured to performing digital beamforming on the plurality of analogue beams.

The radio node 110 may further be configured to, e.g. by means of the generating unit 1120 in the radio node 110, generate the second analogue beam based on the second instruction.

The second analogue beam may be adapted to be generated by performing beamforming in the digital domain between the respective third analogue beams.

The radio node 110 is further configured to, e.g. by means of a receiving unit 1130 in the radio node 110, receive, from a network node 111, the first instruction adapted to instruct the radio node 110 to generate respective analogue beams.

The radio node 110 may further be configured to, e.g. by means of the receiving unit 1130 in the radio node 110, receive, from the network node 111, the second instruction adapted to instruct the radio node 110 to generate the second analogue beam by generating respective third analogue beams at the plurality of subarrays in the column of subarrays. The respective third analogue beams are adapted to be identical to the selected first analogue beam, wherein the second analogue beam is adapted to be used to communicate with the UE 121.

The embodiments herein may be implemented through a respective processor or one or more processors, such as the processor 1150 of a processing circuitry in the radio node 110, depicted in FIG. 11a, together with respective computer program code for performing the functions and actions of the embodiments herein. The program code mentioned above may also be provided as a computer program product, for instance in the form of a data carrier carrying computer program code for performing the embodiments herein when being loaded into the radio node 110. One such carrier may be in the form of a CD ROM disc. It is however feasible with other data carriers such as a memory stick. The computer program code may furthermore be provided as pure program code on a server and downloaded to the radio node 110.

The radio node 110 may further comprise a memory 1160 comprising one or more memory units. The memory comprises instructions executable by the processor 1150 in the radio node 110. The memory 1160 is arranged to be used to store e.g. information, messages, indications, beam settings, configurations, beam selections, quality data, communication data and applications to perform the methods herein when being executed in the radio node 110.

In some embodiments, a computer program 1170 comprises instructions, which when executed by the respective at least one processor 1150, cause the at least one processor 1150 of the radio node 110 to perform the actions above.

In some embodiments, a respective carrier 1180 comprises the respective computer program 1170, wherein the carrier 1180 is one of an electronic signal, an optical signal, an electromagnetic signal, a magnetic signal, an electric signal, a radio signal, a microwave signal, or a computer-readable storage medium.

Those skilled in the art will appreciate that the units in the radio node 110 described above may refer to a combination of analogue and digital circuits, and/or one or more processors configured with software and/or firmware, e.g. stored in the radio node 110, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

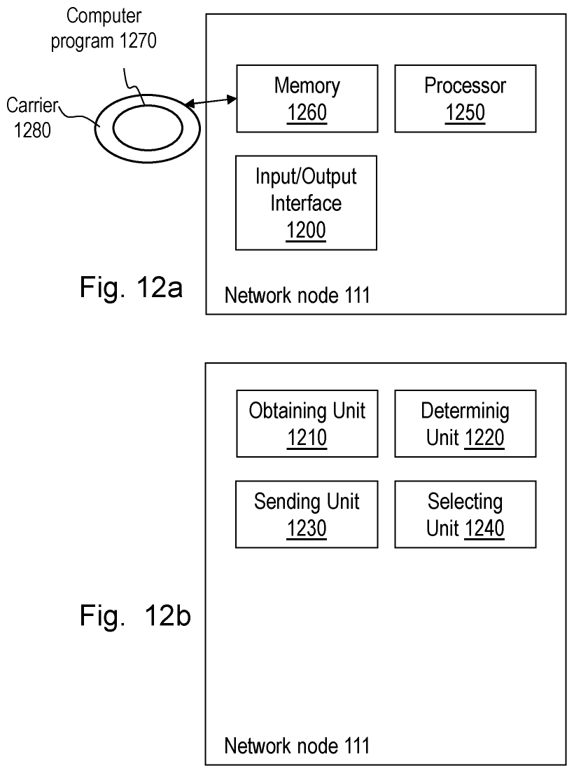

To perform the method actions, the network node 111 may comprise an arrangement depicted in FIGS. 12a and b. The network node 111 is configured to handle beamforming of a beam adapted to be used to communicate with the UE 121 in the wireless communications network 100. The network node 111 may be adapted to be any one out of a baseband node 111, or a cloud node 111 adapted to implement the functionality of a baseband node. When the network node 111 is a baseband node 111, the baseband node 111 may be adapted to be collocated with the radio node 110 or adapted to be located separate from the radio node 110.

The network node 111 may comprise an input and output interface 1200 configured to communicate with e.g. the UE 121 and with network nodes in the communications network 100.

The network node 111 may further be configured to, e.g. by means of an obtaining unit 1210 in the network node 111, obtain a plurality of beam settings for generating analogue beams.

The network node 111 is further configured to, e.g. by means of a determining unit 1220 in the network node 111, determine respective analogue beams to be generated at respective subarrays among a plurality of subarrays in a column of subarrays in the radio node 110. At least one of the respective analogue beams is adapted to be different from the other respective analogue beams.

All the respective analogue beams may be adapted to be different analogue beams.

The determined respective analogue beams may be adapted to be associated to respective beam settings from the plurality of beam settings.

The network node 111 is further configured to, e.g. by means of a sending unit 1230 in the network node 111, send, to the radio node 110, the first instruction adapted to instruct the radio node 110 to generate the determined respective analogue beams.

The first instruction may be adapted to comprise any one or more out of the respective beam settings, and the indication of the respective beam settings.

The network node 111 may further be configured to, e.g. by means of the sending unit 1230 in the network node 111, send, to the radio node 110, the second instruction adapted to instruct the radio node 110 to generate a second analogue beam by generating respective third analogue beams at the plurality of subarrays in the column of subarrays. The respective third analogue beams are adapted to be identical to the selected first analogue beam. The second analogue beam is adapted to be used to communicate with the UE 121.

The network node 111 is further configured to, e.g. by means of a selecting unit 1240 in the network node 111, select a first analogue beam based on a respective quality of the plurality of analogue beams. The selected first analogue beam is the analogue beam with the highest quality. Communication with the UE 121 is adapted to be based on the selected first analogue beam.

The embodiments herein may be implemented through a respective processor or one or more processors, such as the processor 1250 of a processing circuitry in the network node 111, depicted in FIG. 12a, together with respective computer program code for performing the functions and actions of the embodiments herein. The program code mentioned above may also be provided as a computer program product, for instance in the form of a data carrier carrying computer program code for performing the embodiments herein when being loaded into the network node 111. One such carrier may be in the form of a CD ROM disc. It is however feasible with other data carriers such as a memory stick. The computer program code may furthermore be provided as pure program code on a server and downloaded to the network node 111.

The network node 111 may further comprise a memory 1260 comprising one or more memory units. The memory comprises instructions executable by the processor 1250 in the network node 111. The memory 1260 is arranged to be used to store e.g. information, messages, indications, beam settings, configurations, beam selections, quality data, communication data and applications to perform the methods herein when being executed in the network node 111.

In some embodiments, a computer program 1270 comprises instructions, which when executed by the respective at least one processor 1250, cause the at least one processor 1250 of the network node 111 to perform the actions above.

In some embodiments, a respective carrier 1280 comprises the respective computer program 1270, wherein the carrier 1280 is one of an electronic signal, an optical signal, an electromagnetic signal, a magnetic signal, an electric signal, a radio signal, a microwave signal, or a computer-readable storage medium.

Those skilled in the art will appreciate that the units in the network node 111 described above may refer to a combination of analogue and digital circuits, and/or one or more processors configured with software and/or firmware, e.g. stored in the network node 111, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

### Further Extensions and Variations

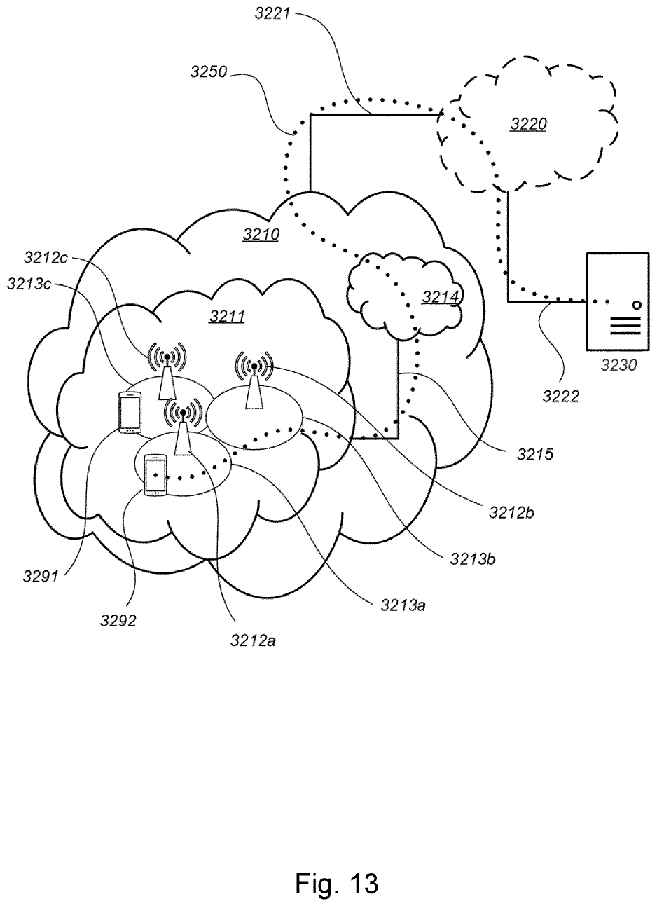

With reference to FIG. 13, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, e.g. the radio node 110, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as the UE 121 and/or a Non-AP STA 3291 located in coverage area 3213c is configured to wirelessly connect to, or be paged by, the corresponding base station 3212c. A second UE 3292 and/or a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 13 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

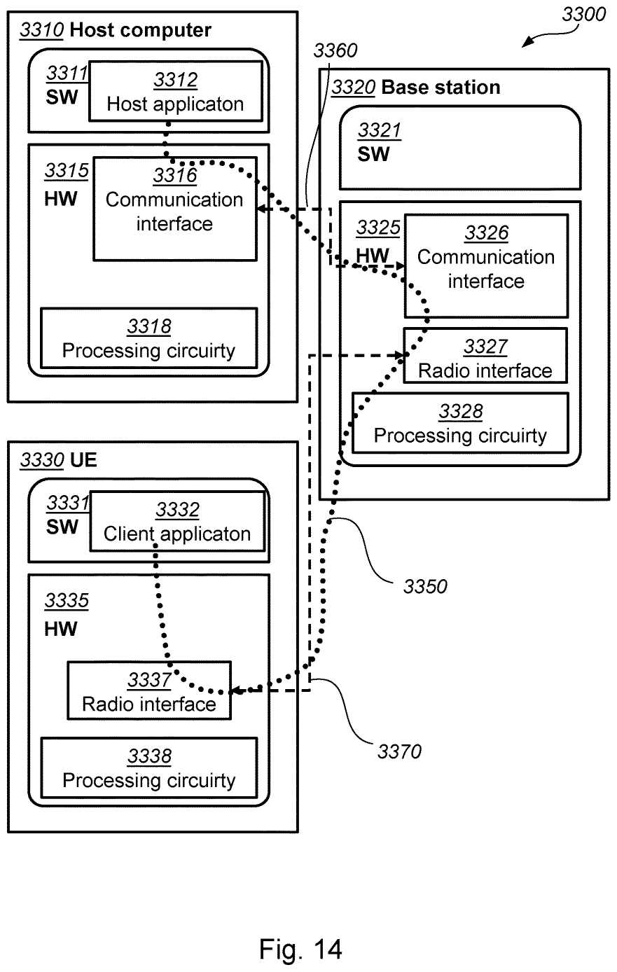

Example implementations, in accordance with an embodiment, of the UE, base station and host computer discussed in the preceding paragraphs will now be described with reference to FIG. 14. In a communication system 3300, a host computer 3310 comprises hardware 3315 including a communication interface 3316 configured to setup and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 14) served by the base station 3320. The communication interface 3326 may be configured to facilitate a connection 3360 to the host computer 3310. The connection 3360 may be direct or it may pass through a core network (not shown in FIG. 14) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to setup and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 14 may be identical to the host computer 3230, one of the base stations 3212a, 3212b, 3212c and one of the UEs 3291, 3292 of FIG. 13, respectively. This is to say, the inner workings of these entities may be as shown in FIG. 14 and independently, the surrounding network topology may be that of FIG. 13.

In FIG. 14, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the [select the applicable RAN effect: data rate, latency, power consumption] and thereby provide benefits such as [select the applicable corresponding effect on the OTT service: reduced user waiting time, relaxed restriction on file size, better responsiveness, extended battery lifetime].

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

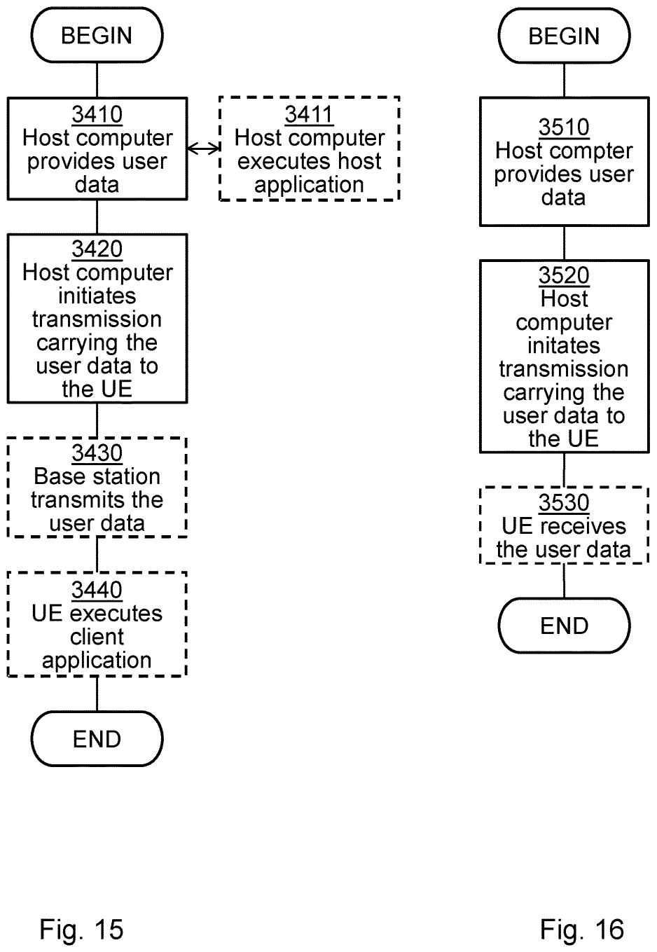

FIG. 15 is a flowchart illustrating a method implemented in a communication system, in accordance with one embodiment. The communication system includes a host computer, a base station such as a AP STA, and a UE such as a Non-AP STA which may be those described with reference to FIG. 13 and FIG. 14. For simplicity of the present disclosure, only drawing references to FIG. 15 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 16 is a flowchart illustrating a method implemented in a communication system, in accordance with one embodiment. The communication system includes a host computer, a base station such as a AP STA, and a UE such as a Non-AP STA which may be those described with reference to FIG. 13 and FIG. 14. For simplicity of the present disclosure, only drawing references to FIG. 16 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

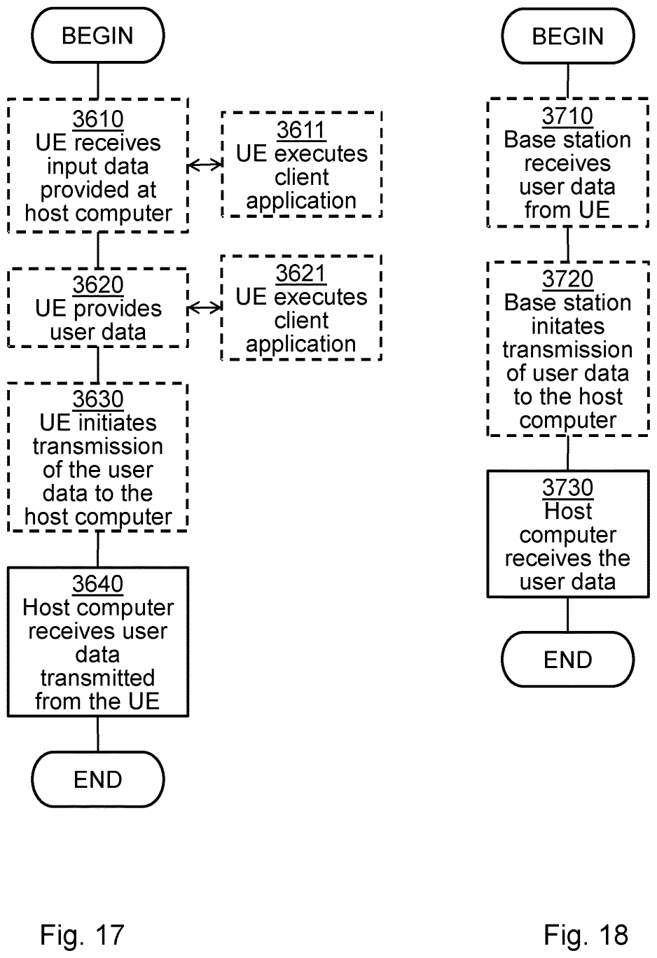

FIG. 17 is a flowchart illustrating a method implemented in a communication system, in accordance with one embodiment. The communication system includes a host computer, a base station such as a AP STA, and a UE such as a Non-AP STA which may be those described with reference to FIG. 13 and FIG. 14. For simplicity of the present disclosure, only drawing references to FIG. 17 will be included in this section. In an optional first step 3610 of the method, the UE receives input data provided by the host computer. Additionally, or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station such as an AP STA, and a UE such as a Non-AP STA which may be those described with reference to FIG. 13 and FIG. 14. For simplicity of the present disclosure, only drawing references to FIG. 18 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1-29. (canceled)

30. A method performed by a radio node for handling beamforming of beams to be used for communicating with a User Equipment (UE) in a wireless communications network, which radio node comprises an antenna array comprising a plurality of subarrays, wherein a subarray of the plurality of subarrays comprises one or more elements connected to an analogue beamformer (ABF) associated to the subarray, the method comprising:
receiving, from a network node, a first instruction instructing the radio node to generate respective analogue beams; and
generating, at a plurality of subarrays in a column of subarrays, the respective analogue beams based on the first instruction, the analogue beam for a subarray being generated by the associated ABF, wherein at least one of the respective analogue beams is different from the other respective analogue beams.

31. The method according to claim 30, wherein all the respective analogue beams are different analogue beams.

32. The method according to claim 30, further comprising:
receiving, from the network node, a second instruction instructing the radio node to generate a second analogue beam by generating respective third analogue beams at the plurality of subarrays in the column of subarrays, wherein respective third analogue beams are identical to the selected first analogue beam, and wherein the second analogue beam is used for communicating with the UE; and
generating the second analogue beam based on the second instruction.

33. The method according to claim 32, wherein the second analogue beam is generated by performing beamforming in the digital domain between the respective third analogue beams.

34. The method according to claim 30, further comprising:
obtaining a plurality of beam settings for generating analogue beams; and
wherein the respective analogue beams are generated based on the obtained beam settings.

35. The method according to claim 30, wherein generating the respective analogue beams further comprises performing digital beamforming of the respective analogue beams.

36. A method performed by a network node for handling beamforming of beams to be used for communicating with a User Equipment (UE) in a wireless communications network, the method comprising:
determining respective analogue beams to be generated at respective subarrays among a plurality of subarrays in a column of subarrays in a radio node, wherein at least one of the respective analogue beams is different from the other respective analogue beams;
sending, to the radio node, a first instruction instructing the radio node to generate the determined respective analogue beams; and
selecting a first analogue beam based on a respective quality of the plurality of analogue beams, wherein the selected first analogue beam is the analogue beam with the highest quality, wherein communication with the UE is based on the selected first analogue beam.

37. The method according to claim 36, wherein all the respective analogue beams are different analogue beams.

38. The method according to claim 36, further comprising sending, to the radio node, a second instruction instructing the radio node to generate a second analogue beam by generating respective third analogue beams at the plurality of subarrays in the column of subarrays, wherein respective third analogue beams are identical to the selected first analogue beam, and wherein the second analogue beam is used for communicating with the UE.

39. The method according to claim 36, further comprising:
obtaining a plurality of beam settings for generating analogue beams; and
wherein the determined respective analogue beams are associated to respective beam settings from the plurality of beam settings; and
wherein the first instruction comprises one or more of:
the respective beam settings, and
an indication of the respective beam settings.

40. The method according to claim 36, wherein the network node is one of:
a baseband node; and
a cloud node implementing the functionality of a baseband node.

41. The method according to claim 40, wherein the network node is a baseband node and is collocated with, or located separately from, the radio node.

42. A radio node configured to handle beamforming of beams adapted to be used to communicate with a User Equipment (UE) in a wireless communications network, wherein the radio node is configured to comprise an antenna array adapted to comprise a plurality of subarrays, and wherein a subarray of the plurality of subarrays is configured to comprise one or more elements connected to an analogue beamformer (ABF) adapted to be associated to the subarray, the radio node further being configured to:
receive, from a network node, a first instruction adapted to instruct the radio node to generate respective analogue beams; and
generate, at a plurality of subarrays in a column of subarrays, the respective analogue beams based on the first instruction, the analogue beam for a subarray adapted to be generated by the associated ABF, wherein at least one of the respective analogue beams is adapted to be different from the other respective analogue beams.

43. The radio node according to claim 42, further configured to:
receive, from the network node, a second instruction configured to instruct the radio node to generate a second analogue beam by generating respective third analogue beams at the plurality of subarrays in the column of subarrays, wherein respective third analogue beams are configured to be identical to the selected first analogue beam, and wherein the second analogue beam is adapted to be used to communicate with the UE; and
generate the second analogue beam based on the second instruction, wherein the second analogue beam is configured to be generated by performing beamforming in the digital domain between the respective third analogue beams.

44. The radio node according to claim 42, further configured to:
obtain a plurality of beam settings for generating analogue beams; and
wherein the radio node is further configured to generate the respective analogue beams based on the obtained beam settings.

45. The radio node according to claim 42, wherein the radio node is configured to generate the plurality of analogue beams by further being configured to perform digital beamforming on the plurality of analogue beams.

46. A network node configured to handle beamforming of beams adapted to be used to communicate with a User Equipment (UE) in a wireless communications network, the network node configured to:
determine respective analogue beams to be generated at respective subarrays among a plurality of subarrays in a column of subarrays in a radio node, wherein at least one of the respective analogue beams is adapted to be different from the other respective analogue beams;
send, to the radio node, a first instruction adapted to instruct the radio node to generate the determined respective analogue beams; and
select a first analogue beam based on a respective quality of the plurality of analogue beams, wherein the selected first analogue beam is the analogue beam with the highest quality, wherein communication with the UE is adapted to be based on the selected first analogue beam.

47. The network node according to claim 46, wherein all the respective analogue beams are adapted to be different analogue beams.

48. The network node according to claim 46, further configured to send, to the radio node, a second instruction adapted to instruct the radio node to generate a second analogue beam by generating respective third analogue beams at the plurality of subarrays in the column of subarrays, wherein respective third analogue beams are adapted to be identical to the selected first analogue beam, and wherein the second analogue beam is adapted to be used to communicate with the UE.

49. The network node according to claim 46, further configured to:
obtain a plurality of beam settings for generating analogue beams; and
wherein the determined respective analogue beams are adapted to be associated to respective beam settings from the plurality of beam settings; and
wherein the first instruction is adapted to comprise one or more of:
the respective beam settings, and
an indication of the respective beam settings.
